(19) United States
(12) Patent Application Publication
(10) Pub. No.: US 2018/0245396 A1
(43) Pub. Date: Aug. 30, 2018

(54) WINDOW INSULATION SYSTEM

(71) Applicant: John Aaron Gilliam, Philadelphia, PA (US)

(72) Inventor: John Aaron Gilliam, Philadelphia, PA (US)

(21) Appl. No.: 15/904,287

(22) Filed: Feb. 23, 2018

Related U.S. Application Data
(60) Provisional application No. 62/600,464, filed on Feb. 23, 2017.

(51) Int. Cl. E06B 3/28; E06B 3/08

(52) U.S. Cl. CPC E06B 3/28; E06B 3/08

(57) ABSTRACT

A window insulation system comprising a flexible frame, an insulating film, attached and surrounded by the flexible frame, for insulating the interior of a home from the window, at least one support wrapped around a portion of the flexible frame, wherein the at least one support is configured to maintain a frame shape around the window, and a valve, attached to the flexible frame, configured to control the inflation of the flexible frame, to seal the window.

### TECHNICAL FIELD

This disclosure relates to windows. More specifically, this disclosure relates to a window insulation system.

### BACKGROUND

Drafty windows in a home during summer or winter can wreak havoc on the efficient heating and cooling of the home and the home owner's budget. Preventing the escape of air through a window is key to ensuring deficiency and reducing the amount of money used to keep the home a comfortable temperature.

Current methods of insulating drafty windows may use a window film that is applies to the indoor window frame using double-sided tape. This film creates a barrier between the interior of the home and the window.

Another method includes the use of bubble wrap, which is placed over a wet window. Tape is then used on the edges of the wrap to keep warm or cool air inside the home.

A removable magnetic window insulation may also be used to insulate a window. Several coats of magnetic paint can be applied to the window trim, the vinyl is cut to fit the window, and magnetic tape is attached to the vinyl. The magnetic tape holds the vinyl to the magnetic paint, thereby insulating the window from the interior.

These insulating methods, though, require that the insulating be cut specifically to the size of the window and, in some cases, not reusable. Once the insulation is applied to the window, the insulation cannot be taken off and reapplied to the window at a later date. Therefore, there exists a need for a window insulation system to address these and other concerns with current systems.

### SUMMARY

Disclosed herein are implementations of a window insulation system comprising a flexible frame, an insulating film, attached and surrounded by the flexible frame, for insulating the interior of a home from the window, at least one support wrapped around a portion of the flexible frame, wherein the at least one support is configured to maintain a frame shape around the window, and a valve, attached to the flexible frame, configured to control the inflation of the flexible frame, to seal the window.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is an example illustration of a window insulation system in accordance with a disclosed embodiment.

FIG. 2 is an example zoomed in illustration of one of the corner supports shown in FIG. 1.

FIG. 3 is an example zoomed in illustration of one of the adjusters shown in FIG. 1.

FIG. 4 is an example flow diagram of a method for installing the window insulation system in accordance with a disclosed embodiment.

FIG. 5 is an example illustration of FIG. 1 installed in a window frame in accordance with a disclosed embodiment.

### DETAILED DESCRIPTION

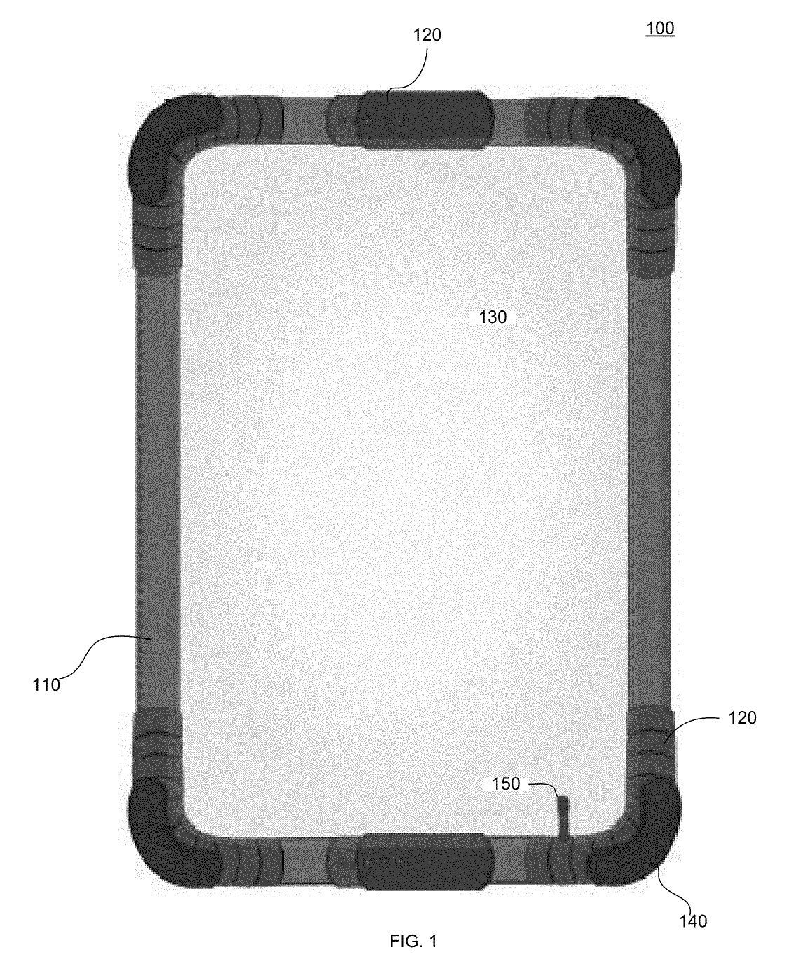

A window insulation system is disclosed. FIG. 1 is an example window insulation system 100 in accordance with a disclosed embodiment. The insulation system 100 comprises a flexible frame 110, at least one support 120, and a film 130. The flexible frame 110 may be made from a flexible material that can be expanded and contracted. For purposes of this disclosure, the flexible frame is made from a tubular rubber material in which the shape and size of the frame is adjustable, for example, an inner tube.

The frame 110 includes an input valve 150 that controls the flow of a gas or liquid for the expansion and/or contraction of the frame 110. For example, valve 150 may be an air-valve, in which air may be pumped into, or out of, the frame to adjust the size and shape of the frame to fit a window. The valve 150 may be any type of valve that can be open and closed. In this disclosure, an inner tube valve is disclosed to regulate the input of air into the frame and out of the frame.

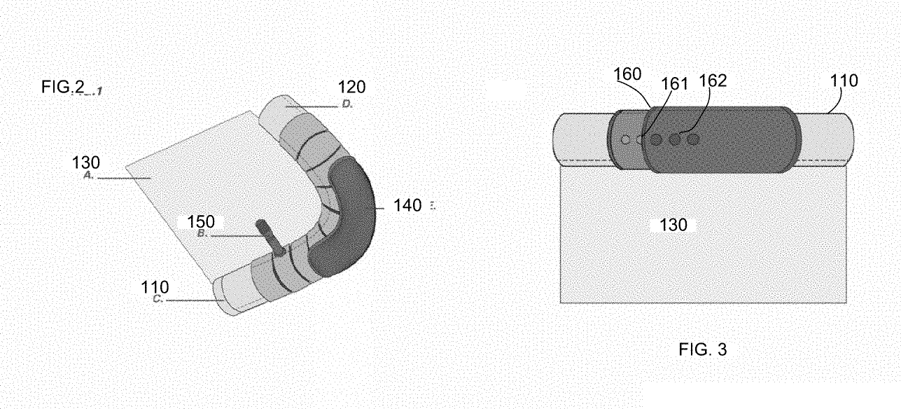

An illustration of an example support 120 installed on the frame 110 to create a corner support is shown in FIG. 2. The support 120 may be placed throughout the length of the frame 110 to maintain a desired shape and size of the frame 110. The support 120 may be made from any material, for example, the same material as the frame 110, i.e., rubber. The material of the support 120 may be any material that allows the frame to be supported in a desired shape. For example, support may be made from reinforced rubber, plastic or a light weight metal, so long as the support maintains its rigidity regardless of the size of the frame. The supports may also be capable of expanding and contracting along with the frame. In an embodiment, the valve 150 may be located within a support, as shown in FIGS. 1-3. In an embodiment, the support 120 is movable along the frame 110 for additional adjustment flexibility.

In an embodiment, an adjuster 160 is included in the insulation system 100. An illustration of an example adjuster 160 is shown in FIG. 3. The adjuster 160, a coupling that allows a length of the frame 100 to be expanded. For example, the length of the frame side that includes the adjuster is at its shortest when the adjuster is set to the first adjustment position 161. When the adjuster 160 is set to the second adjustment position 162, the length of the frame side is longer. The number of adjustment positions and the distance between each position determines the length range the frame side is capable of expanding to, e.g., 28″ to 32″.

In an embodiment, the adjustment positions are set by adjustment buttons 161, 162 such that when a button 161, 162 is depressed, the adjuster 160 may slide to the next adjustment position, and maintain the position once the button 161, 162 is located in the desired adjustment position.

Referring back to FIG. 1, the insulating film 130 is surrounded by, and attached to, the frame 110. In an embodiment, the film 130 is made from a flexible material that can be stretched as the size of the frame 110 is adjusted, for example, a clear polyolefin. The film 130 acts as the insulator to keep warm or cold air from coming in the through the interior of the window, creating a barrier between the window and the inside of the home.

In an embodiment, the insulation system 100 includes one or more fasteners 140. The fastener 140 is attached to a support 120 to help secure the insulation system 100 to a window frame. The fastener 140 is located on the support 120. The fastener 140 includes a male portion and a female portion, wherein the male portion may be attached to the support 120 and the female portion may be attached to a window frame. When the male portion and female portion are mated, the support 120 is secured to the window frame. An example fastener 140 may be a hook and loop fastener, wherein the loop portion may be attached to the support 120 and the hook portion of the fastener may be attached to a window frame. The insulation system 100 is then secured to the window frame when the hook and loop portions are mated.

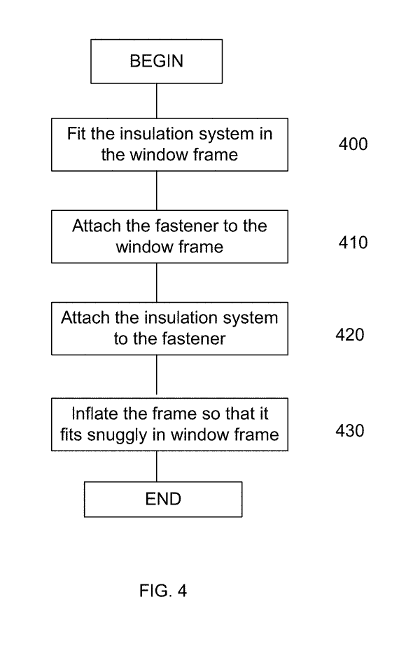

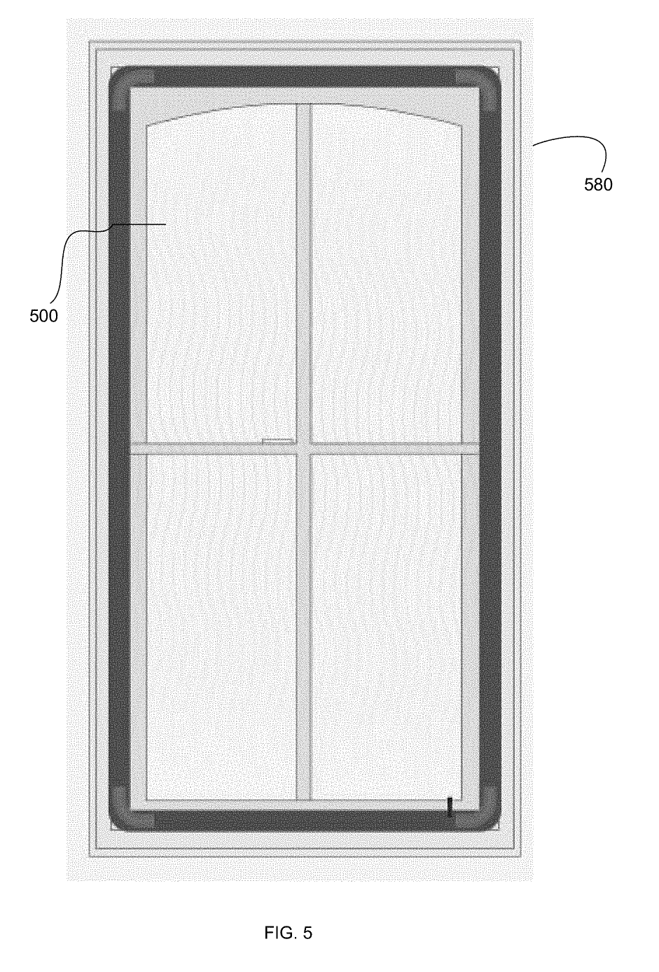

An example flow diagram for installing an embodiment of the insulation system is shown in FIG. 4. A deflated frame of a window insulation system is sized to fit within a window frame 400. Attach the female portion of a fastener to each corner of the window frame and a male portion of the fastener to each corner support on the insulation system 410. Mate the male portion of the each fastener to the female portion of the fastener for each corner support of the insulation system 420. Inflate the frame of the insulation system using an inflation device through the valve until the insulation system frame fits snugly within the window frame 430. FIG. 5 is an example illustration of an embodiment of the insulation system 500 installed in the window frame 580.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A window insulation system comprising:
a flexible frame;
an insulating film, attached and surrounded by the flexible frame, for insulating the interior of a home from the window;
at least one support wrapped around a portion of the flexible frame, wherein the at least one support is configured to maintain a frame shape around the window; and
a valve, attached to the flexible frame, configured to control the inflation of the flexible frame, to seal the window.
